(19) United States
(12) Patent Application Publication
(10) Pub. No.: US 2026/0296982 A1
(43) Pub. Date: Oct. 1, 2026

(54) METHOD AND APPARATUS FOR BINDING CARBON DIOXIDE, OBTAINED PRODUCT AND USE THEREOF

(71) Applicant: CARBONAIDE OY, Joensuu (FI)

(72) Inventor: Tapio Vehmas, Kirkkonummi (FI)

(21) Appl. No.: 18/880,559

(22) PCT Filed: Jun. 28, 2023
(86) PCT No.: PCT/FI2023/050401

§ 371 Date: Jan. 1, 2025

(30) Foreign Application Priority Data
Jul. 4, 2022 (FI) 20225625

(51) Int. Cl. C04B 40/02; B01D 53/62; B28B 11/24

(52) U.S. Cl. CPC C04B 40/0231; B01D 53/62; B28B 11/245; B01D 2257/504

(57) ABSTRACT

The disclosure relates to a method for improving gas penetration, characterized in that the method comprises placing one or more porous item(s) in at least one of two interconnected spaces; adding carbon dioxide gas and subjecting the porous item to pressure fluctuation. According to an embodiment of the disclosure the pressure fluctuation is controlled by a flow adjuster and a motor component attached to the interconnected spaces and the pressure difference of the pressure fluctuation is below 2 kPa. The disclosure also relates to an apparatus for binding carbon dioxide into a porous item, to a product obtainable by the methods of the disclosure and to the use of the product.

### FIELD OF THE DISCLOSURE

The present disclosure relates to a method for improving gas penetration, wherein one or more porous item(s) is placed in at least one of two interconnected spaces, carbon dioxide gas is added, and the porous item is subjected to pressure fluctuation. More particularly the disclosure relates to using pressure fluctuation for improving gas penetration into the porous item. The pressure fluctuation can be controlled by a flow adjuster and a motor component attached to the interconnected spaces. The disclosure further relates to an apparatus for binding carbon dioxide into a porous item, to a product obtainable by the methods of the disclosure and to the use of the product.

### BACKGROUND OF THE DISCLOSURE

Greenhouse gases have far-ranging environmental and health effects. The term climate change is used to describe the complex shifts, driven by greenhouse gas concentrations, that are now affecting our planet's weather and climate systems. Climate change encompasses not only the rising average temperatures we refer to as global warming, but also extreme weather events, rising seas, food supply disruptions, increased wildfires, shifting wildlife populations etc. Carbon dioxide is the greenhouse gas with the highest levels of emissions in the atmosphere.

The world cement production and concrete industry has been recognized to generate a significant part of global carbon dioxide emissions. The emissions come from the calcination process as well as from energy use.

Captured carbon dioxide can be put to productive use in enhanced oil recovery and the manufacture of fuels, building materials, and more, or be stored in underground geologic formations. Low carbon footprint concrete products have been developed using alternative binders replacing cement, using geopolymers and low binder amounts in concrete and using carbon dioxide for curing concrete. However, none of these methods alone have been able to produce carbon negative concrete, when both the emissions of raw materials and their processing are accounted for.

WO 2021105726 A1 discloses a concrete preparation system where carbon dioxide is mixed to a mixture of aggregate material, cement and water in a pretreatment chamber before casting and curing of concrete.

Although climate change and the greenhouse effect are subject for continuous product and process innovation in the field, there is still an urgent need for improvement.

### BRIEF DESCRIPTION OF THE DISCLOSURE

An object of the present disclosure is to provide a method and an apparatus for implementing the method to improve carbon dioxide penetration into porous material such as a porous item, piece or element.

The object of the disclosure is achieved by the method, apparatus and use which are characterized by what is stated in the independent claims. The preferred embodiments of the disclosure are disclosed in the dependent claims.

The disclosure is based on the idea of changing gases in the pores of a porous item by inducing pressure changes in the space where the porous item is placed. The pressure changes cause gas to flow repeatably in and out into the pores of the porous item, thereby causing effective change of gases inside the porosity of the item, like “artificial breathing”.

As the method of the disclosure improves gas penetration into porous materials, an advantage of the method, apparatus and use of the disclosure is that significant carbon dioxide uptake in the product is received, thus reducing the carbon footprint of the products or even leading to products having a negative carbon footprint.

A further advantage of the disclosure is that the pressure fluctuation is small and thus convenient for industrial use. The pressures are typically within normal atmospheric pressure, between the lowest and highest measurable sea-level pressure.

In the method of the disclosure further advantages are obtained when the method is used in curing and optionally also drying concrete or concrete-like items such as pre-casted concrete or concrete-like items with carbon dioxide (carbon curing). Due to the improved gas penetration into the porous items, more carbonate-based minerals are formed, leading to improved mechanical properties of the concrete or concrete-like carbonated product. In the method of the disclosure the formation of carbonate-based minerals is not limited due to poor penetration of carbon dioxide into the porous item and thus the degree of carbonation is higher than in existing carbon curing processes.

With the method of disclosure, the processing time needed for obtaining higher CO2 uptake and/or higher degree of carbonation is typically shorter compared to conventional methods. For example, the curing time may significantly be reduced compared to conventional concrete technology. With the method of the disclosure carbonate minerals typically form within 24 hours or less and thus the method is suitable for manufacturing of concrete and concrete or concrete-like products under industrial conditions.

Advantageously, by the method of the disclosure the CO₂ uptake, i.e. the amount of CO₂ bound to the product, is greater than the carbon footprint of the raw materials, transportation and production (Production according to module A1-3 Product stage in EN 15804+A1), thus for example enabling production of carbon negative concrete or concrete-like products. With the method of the disclosure, the carbon dioxide uptake in the raw material typically reaches over 10 wt. %, preferably over 20 wt. % and more preferably over 30 wt. % counted as the mass of carbon dioxide bound per mass of raw material. Other known carbon dioxide curing methods have typically reached a carbon dioxide uptakes of 4-10% (mass CO₂ bound/mass of binder and/or raw material). A carbon dioxide uptake of the method of the disclosure enables carbon negative concrete or concrete-like products, where the CO₂ footprint of all raw materials, their transportation and processing is smaller than the amount of carbon dioxide bound in the product.

### BRIEF DESCRIPTION OF THE DRAWINGS

In the following the disclosure will be described in greater detail by means of preferred embodiments with reference to the accompanying drawings, in which

FIG. 1 shows a schematic view of one embodiment of the disclosure;

FIG. 2 shows an example of pressure fluctuation according to the method of disclosure; and

FIG. 3 shows mechanical strength results compared to a reference sample.

### DETAILED DESCRIPTION OF THE DISCLOSURE

The disclosure relates to a method for improving gas penetration, characterized in that the method comprises placing one or more porous item(s) in at least one of two interconnected spaces; adding carbon dioxide gas and subjecting the porous item to pressure fluctuation. Preferably the pressure difference of the pressure fluctuation is below 2 kPa.

According to an embodiment of the disclosure the pressure fluctuation is controlled by a flow adjuster and a motor component attached to the interconnected spaces.

The disclosure also relates to an apparatus for binding carbon dioxide into a porous item, preferably for carbonation of a porous item, wherein the apparatus comprises a first space (A) connected to the inlet of a motor component (1) and a second space (B) connected to the motor compound outlet and at least one flow adjuster (2) between the first space (A) and the second space (B).

The disclosure also relates to a product obtainable by the methods of the disclosure, preferably a concrete or concrete-like product as well as the use of the product as building material, preferably for producing concrete or concrete-like products, more preferably for carbonated items, most preferably for pre-casted carbonated items as well as to the use of the method and product in the medical field for example in particle synthesis, in steel industry and/or in construction industry, preferably in construction industry, more preferably for production of concrete or concrete-like products and/or curing concrete or concrete-like items, preferably pre-casted concrete or concrete-like items in a precast concrete factory.

The term “porous” as used herein, means a material which has void gaps and is permeable to outside influences so that for example air, water, or other gases and fluids can flow inside the material. In the porous material the gaps are not occupied by the main framework of atoms that make up the structure of the solid.

In the embodiments of the disclosure the space of the disclosure is typically at least two closed interconnected spaces such as container(s) or chamber(s) or a compartmentalized space divided into compartments. Typically, the space(s) are sealed, and are essentially airtight, in order for the carbon dioxide gas not to get mixed with outside air to any essential extent. Preferably, the space(s) are sealed with a PVC sealing, more preferably with PVC fabric having a minimum density of 630 g/m².

In embodiments of the disclosure gas flow between space A to space B is generated by a motor component and restrained by a flow adjuster which controls the gas flow between Space A and Space B. Restraining gas flow creates over-pressure into space A and underpressure into space B in respect to the initial state pressure. Restoring the flow adjuster into original position restores the initial pressure state. Reversing the gas flow direction creates under-pressure to space A, and over-pressure to space B in respect to the initial state pressure. Adjusting the flow is constantly repeated for between 2 and 48 hours, preferably for between 12 and 48 hours. The processing time, starting when the item(s) are exposed to carbon dioxide gas and continuing until exposing to carbon dioxide gas is stopped, is typically from 2 to 48 hours, preferably from 12 to 48 or from 4 to 36 hours, more preferably from 4 to 30 hours, most preferably from 4 to 24 hours, including the processing time being or being between two of any of the following; 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47 and 48. The fluctuation cycle, for example from highest to lowest pressure and back to highest pressure, typically takes place between 1 time/minute to 1 time/hour preferably between 1 time/hour and 60 times/hour, more preferably from 6 time/hour to 12 times/hour. Typically, the temperature of space (A) and/or (B) during the pressure fluctuation is 20-80° C., preferably 40-60° C. In the method and/or apparatus of the disclosure, temperature, and relative humidity of space (A) and/or (B) is typically monitored and/or controlled by process control systems. The relative humidity of space (A) and/or (B) is typically kept between 10% and 90%, preferably between 40% and 70%, more preferably between 40% and 60%, most preferably between 55% and 60%. In embodiments of the disclosure were cement and cement-like items are cured, a relative humidity between 40% and 70%, more preferably between 55% and 60% or between 40% and 55% is preferred since the curing according to the method of the disclosure does not consume water. In embodiments of the disclosure it is typically preferred, that less water (or humidity) fills up the pores of the porous item contrary to conventional processes. In conventional curing processes post-treatment of casted products is typically done by wetting, using after-treatment agents, leaving the mold in place, with thermal insulation, plastic coverings or by retaining the moisture in the concrete by other methods.

In the embodiments of the disclosure the flow adjuster is typically a valve, preferably a ball valve, butterfly valve, check valve, gate valve, knifegate valve, globe valve, needle valve, pinch valve, plug valve or pressure relief valve, more preferably a butterfly valve.

In the embodiments of the disclosure the motor component is typically a component generating gas flow between space A and space B, preferably the motor component is a blower or fan, more preferably a fan.

In the embodiments of the disclosure the carbon dioxide gas is typically a carbon dioxide comprising gas, preferably the carbon dioxide gas comprises 1-100% carbon dioxide, preferably 1-99% carbon dioxide, more preferably 30-90%, most preferably 40-70% carbon dioxide. In some embodiments of the disclosure the carbon dioxide gas is purified carbon dioxide gas comprising over 99%, preferably 80-100%, more preferably 85-99 %, most preferably 85-95% carbon dioxide, i.e. carbon dioxide gas concentrated to preferred extent by a gas concentration method such as absorption or adsorption methods or by membranes. In preferred embodiments of the disclosure the carbon dioxide gas comprises 1-100% carbon dioxide, preferably 30-90 wt. %, %, more preferably 40-70 % carbon dioxide, or typically 20-30% or 85-95% carbon dioxide and is obtained from industry side stream(s) or by-product(s), a preferred carbon dioxide gas source being power plant or factory flue gas, off gas from a biogas plant or ethanol fermentation, or oil refinery tail gas. The method or apparatus of the disclosure is optionally integrated to the carbon dioxide gas source production process for example by a direct material flow equipment in the same factory area.

In embodiments of the disclosure adding of carbon dioxide gas is preferably done before the pressure fluctuation is started. The carbon dioxide gas can be added all at once, but typically the carbon dioxide gas is added in batches, preferably a first batch is added in the beginning followed by further batches. Typically, the first batch is bigger than the others and typically carbon dioxide gas is further added when needed, for example when the level of carbon dioxide is measured to be below a certain desired level and the level of carbon dioxide can be measured during the pressure fluctuation, by appropriate means for example as part of a process control system. A higher amount of carbon dioxide leads to faster carbonation. The amount of carbon dioxide in space A and/or B is at most essentially the same as the amount of carbon dioxide in the carbon dioxide gas, meaning that the amount of added carbon dioxide gas has replaced the air of space A and/or B. Thus, the preferred levels of carbon dioxide in the process corresponds to the amount of carbon dioxide in the carbon dioxide gas. Typically, the carbon dioxide gas is added to space A and/or space B through at least one inlet connected to one or both spaces, but the carbon dioxide can be added anywhere in the apparatus of the disclosure. Typically, the carbon dioxide gas is added through an inlet for providing carbon dioxide gas and typically air is removed trough an outlet for removing air.

According to embodiments of the disclosure the difference between the initial pressure and the highest pressure and the initial pressure and the lowest pressure in the first space and/or the second space is typically below 2 kPa, preferably about 1 kPa. The lowest and highest pressure is typically between the lowest measurable sea-level pressure of about 87 kPa and the highest measurable sea-level pressure of about 109 kPa. Typically the pressure difference during the pressure fluctuation, compared to the initial pressure when the test is started, is below 2 kPa, preferably between 0.5 and 2 kPa or between 0.5 and 1.8 kPa and more preferably between 0.8 and 1.5 kPa, most preferably between 0.9 and 1.1 kPa, including the lowest and highest pressure being any of the following atmospheric pressures; 87, 88, 89, 90, 91, 92, 93, 94, 95, 96, 97, 98, 99, 100, 101, 101.325, 102, 103, 104, 105, 106, 107, 108 and 109 kPa and the pressure difference being in respect to the initial state pressure. Preferably the pressure fluctuation varies between slightly over and slightly under the initial pressure.

In the embodiments of the disclosure the porous item is a three-dimensional object, piece or structure. Typically, the porous item(s) is a pre-casted concrete or concrete-like item such as hollow-core slabs, bricks, blocks, ashlars, stones, or elements.

Typically, the pre-casted item is prepared by conventional concrete technology by mixing or agitating a mix comprising raw material, aggregates, water and/or binders, which mix is casted or extruded as a concrete. Aggregates and/or binders used are typically aggregates and/or binders known from conventional concrete technology and the mix is typically called a raw mixture. The raw material can comprise cement-like material and/or conventional cement. In some embodiments of the disclosure the raw material is preferably solid and comprises or entirely consist of industrial wastes, residues or side streams. Typically, the raw material comprises or is chosen from slag products such as blast furnace slag, electric arc furnace slags (oxidizing and reducing), ladle furnace slag, steel slag, argon oxygen decarburization slag and basic oxygen furnace slag; ashes such as municipal waste incinerator ashes, cyclone and cloth bag dust, bio based ashes, bark ash, peat ash, coal fly ash and slag, lignite ashes, oil shale ashes and boiler ashes; tailings such as mine tailings and metal tailings such as red mud from alumina refining; other waste products such as cement kiln and by-pass dust, inorganic construction wastes and recycled concrete and any combinations thereof. The particle size of the raw material is typically mainly below 250 μm, preferably between 50 μm and 0.5 μm, meaning that more than 50 % of the particles by volume are of that size. According to embodiments of the disclosure, the raw material itself can function as aggregate and/or binder. In some embodiments the mix further comprises an alkaline substance. The alkaline substance can be pure chemicals or industrial wastes, residues or side streams, especially wastes, residues or side streams of paper industry. Typically, the alkaline substance comprises or consists of basic oxides, alkali and alkaline earth metal oxides, hydroxides, silicates, sulphates and/or mixtures and/or aqueous solutions thereof. In the embodiments of the disclosure the alkaline substance can comprise or be chosen from the group consisting of NaOH, Na₂O, Mg(OH)₂, MgO, Ca(OH)₂, CaO, KOH, K₂O, green liquor dregs, paper sludge and lime kiln residues and any combinations thereof, preferably chosen from green liquor dregs, paper sludge and lime kiln residues.

In some embodiments of the disclosure the pre-casted concrete or concrete-like item is cured by the carbon dioxide gas and the carbonate minerals formed in the cured product strengthens the structure of the product.

In the embodiments of the disclosure the degree of carbonation is typically over 40% of the theoretical degree of carbonation, preferably between 40% and 95%, more preferably between 55% and 85%, most preferably between 70% and 80% of the theoretical degree of carbonation. The degree of carbonation is calculated as percentage of the theoretical degree of carbonation for the total dry weight of carbonable material of the raw mixture. For example, the theoretical value for calcium oxide is 79% (wt.) of the total dry weight.

Mechanical strength properties are typically measured by SFS-EN 12350, SFS-EN 12504 and/or SFS-EN 13791.In preferred embodiments of the disclosure the mix is cured until desired CO₂ uptake of the product is observed. The CO₂ uptake is counted as the mass of CO₂ bound per mass of raw material and it is preferably between 10 wt. % and 100 wt. %, more preferably between 20 wt. % and 45 wt. %, most preferably between 30 wt. % and 45 wt. %, including the uptake being between any of the following; 4 wt. %, 5 wt. %, 6 wt. %, 7 wt. %, 8 wt. %, 9 wt. %, 10 wt. %, 11 wt. %, 12 wt. %, 13 wt. %, 14 wt. %, 15 wt. %, 20 wt. %, 25 wt. %, 30 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. %, 90 wt. %, 95 wt. % and 100 wt. %. Typically, the CO₂ uptake is over 10 wt. %, preferably over 20 wt. % and more preferably over 30 wt. % counted as the mass of CO₂ bound per mass of raw material. The amount can be higher than the amount of CO₂ set free during production of the raw material, during using the method of the disclosure and/or during manufacturing of the concrete or concrete-like item and thus the carbon footprint can be negative.

### EXAMPLES

### Example 1

A test piece, which fulfils the strength requirements of concrete used in building structures, was prepared. The test piece was manufactured from Portland cement 310 kg/m³ , water 140 kg/m³, aggregates 2080 kg/m³. Test piece was manufactured using standard pre-cast concrete product machinery.

### Example 2

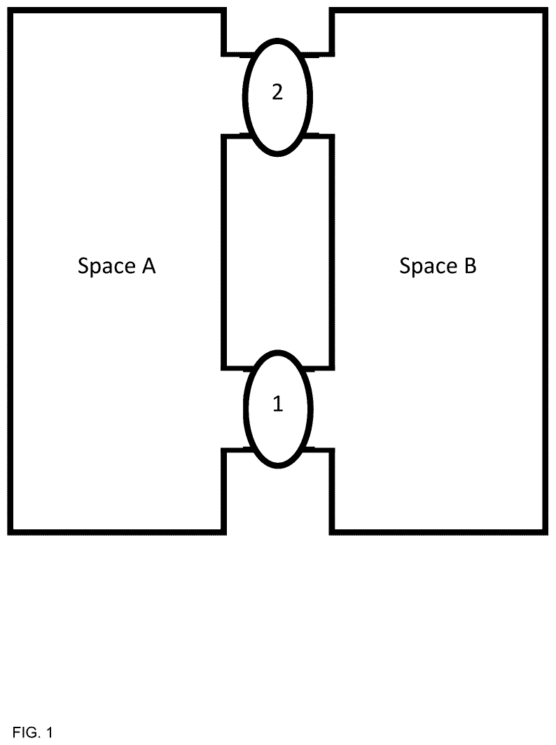

The test piece of Example 1 was placed in a first space (A) of an apparatus according to FIG. 1. Space A was connected to the inlet of a centrifugal fan and a second space (B) was connected to the blower outlet. A butterfly valve was used as flow adjuster (2) between the first space (A) and the second space (B). Carbon dioxide gas (comprising 100% of carbon dioxide) was led into the process through a magnetic valve and air was removed through another valve.

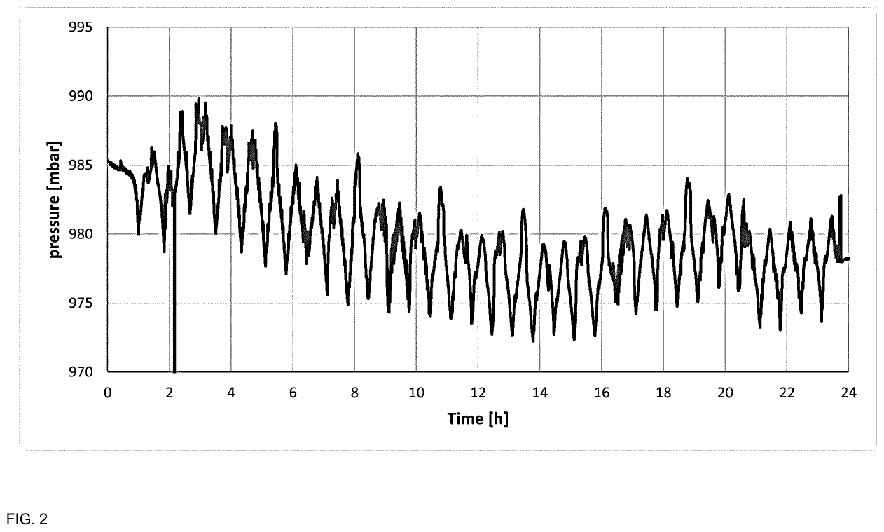

The gas flow from space A to space B was restrained by the butterfly valve which created an underpressure into space A of 0.5 kPa and an overpressure of 0.5 kPa respect to the initial state which was 98.5 kPa (FIG. 2). Restoring the flow adjuster into original position restored the initial pressure state and adjusting the flow was constantly repeated. The pressure varied between 99 kPa to 97 kPa and the pressure difference was below about 1.5 kPa compared to the initial pressure. The processing time was 24 hours from starting to expose the piece to carbon dioxide gas to stopping the pressure fluctuation and ending the exposure to carbon dioxide gas.

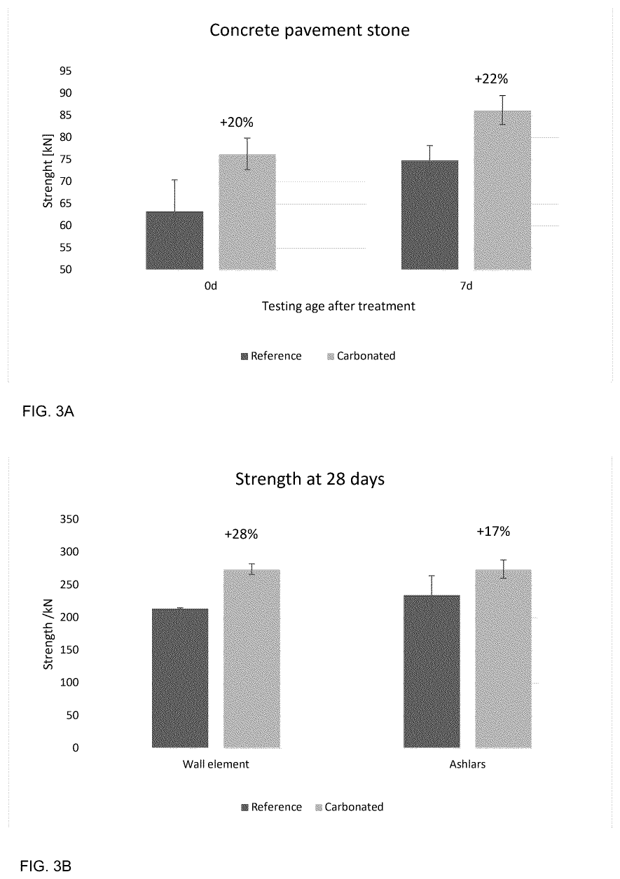

The compressive strength of the produced test piece and reference sample from standard precast concrete production were measured. The produced test piece was measured directly after ending the exposure to carbon dioxide gas (FIGS. 3A, 0 days). As can be seen from FIG. 3A, the compression strength of the test piece increased 20% compared to the reference sample. After 7 days the increase was 22% compared to the reference sample.

The test piece absorbed 2.7% of CO₂ from total dry weight, corresponding to 22% from raw material weight, measured directly after ending the exposure to carbon dioxide gas. The degree of carbonisation was 44% of the theoretical carbonisation. Due to carbonisation, the carbon footprint of the test piece was reduced by 22%.

### Example 3

Test pieces of lightweight ashlars and wall elements were cured in similar conditions as Example 2. The reference test pieces were similar lightweight ashlars and wall elements, from the same batches which were cured without carbonation. As can be seen from FIG. 3B, the compression strength of the ashlars increased 17% compared to reference ashlars. The degree of carbonisation was 76% of the theoretical carbonisation and the test piece absorbed CO₂ 38% of initial raw material weight. The compression strength of the wall elements increased 28% compared to reference wall elements.

1. A method for improving gas penetration, characterized in that the method comprises
placing one or more porous item(s) in at least one of two interconnected spaces;
adding carbon dioxide gas;
subjecting the porous item to pressure fluctuation;
wherein the pressure difference of the pressure fluctuation is between 0.5 and 2 kPa.

2. The method according to claim 1, characterized in that the method further comprises that the pressure fluctuation is controlled by a flow adjuster and a motor component attached to the interconnected spaces.

3. The method according to any of the preceding claims, characterized in that the pressure difference during the pressure fluctuation is between 0.8 and 1.5 kPa, preferably between 0.9 and 1.1 kPa.

4. The method according to any of the preceding claims, characterized in that the porous item(s) is a pre-casted concrete or pre-casted concrete-like item.

5. The method according to claim 4, characterized in that the pre-casted concrete or concrete-like item is cured by the carbon dioxide gas.

6. The method according to any of the preceding claims, characterized in that the carbon dioxide gas comprises 1-100% carbon dioxide, preferably 1-99% carbon dioxide, more preferably 30-90%, more preferably 40-70% carbon dioxide and/or the processing time is from 2 to 48 hours, preferably from 4 to 36 hours, more preferably from 4 to 30 hours, most preferably from 4 to 24 hours.

7. The method according to any of the preceding claims, characterized in that the carbon dioxide gas is obtained from industry side streams, preferably from power plant or factory flue gas or other side streams such as off gas from a biogas plant or ethanol fermentation or oil refinery tail gas.

8. The method according to any of the preceding claims, characterized in that during the pressure fluctuation, temperature of space (A) and/or (B) is 20-80° C., preferably 40-60° C., and/or relative humidity of space (A) and/or (B) is between 10% and 90%, preferably between 40% and 70%, more preferably between 40% and 60%, most preferably between 55% and 60%.

9. An apparatus for binding carbon dioxide into a porous item characterized in that the apparatus comprises a first space (A) connected to the inlet of a motor component (1) and a second space (B) connected to the motor compound outlet and at least one flow adjuster (2) between the first space (A) and the second space (B), wherein the apparatus further comprises process control systems for monitoring and controlling temperature and humidity in space(s) (A) and/or (B) and an inlet for providing carbon dioxide gas.

10. The apparatus according to claim 9, characterized in that the apparatus is integrated to a carbon dioxide gas source production process in a common factory area.

11. A product obtainable by the method of any of claims 1 to 8, characterized in that the product has a degree of carbonation between 40% and 95%, more preferably between 55% and 85%, most preferably between 70% and 80% of the theoretical degree of carbonation, preferably the product is a concrete or concrete-like product.

12. The product according to claim 11, characterized in that the CO₂ uptake of the product is between 10 and 100 wt. %, preferably between 20 and 45 wt. %, more preferably between 30 and 45 wt. % counted as mass of CO₂ per mass of raw material.

13. The method according to claim 1 to 8 or the apparatus according to claims 9 to 10, wherein the flow adjuster is a valve, preferably a ball valve, butterfly valve, check valve, gate valve, knifegate valve, globe valve, needle valve, pinch valve, plug valve or pressure relief valve, more preferably a butterfly valve.

14. The method according to claim 1 to 8 or the apparatus according to claims 9 to 10, characterized in that the motor component is a component generating gas flow between space A and space B, preferably the motor component is a blower or fan, more preferably a fan.

15. Use of the method of any of claims 1 to 8 in the medical field, in steel industry and/or in construction industry, preferably in construction industry for production of concrete or concrete-like products.

16. Use of the product of claim 11 or 12 as building material, preferably for curing concrete or concrete-like products, more preferably for curing pre-casted items.
